(19) United States
(12) Patent Application Publication
(10) Pub. No.: US 2025/0360041 A1
(43) Pub. Date: Nov. 27, 2025

(54) Funeral Service Container

(71) Applicant: Heaven's Gain Ministries, Cincinnati, OH (US)

(72) Inventor: James Anthony Murphy, Cincinnati, OH (US)

(73) Assignee: Heaven's Gain Ministries, Cincinnati, OH (US)

(21) Appl. No.: 19/216,426

(22) Filed: May 22, 2025

Related U.S. Application Data
(60) Provisional application No. 63/651,308, filed on May 23, 2024.

(51) Int. Cl. A61G 17/02

(52) U.S. Cl. CPC A61G 17/02

(57) ABSTRACT

A funeral service container includes a reusable casket and a hingedly connected lid, a box sized to be received therein, and a reusable circumferential frame that spans and surrounds the corresponding upper edges of the outer casket and the inner box, thereby to enable the casket and box to resemble the appearance of a decorative casket during a funeral ceremony or service. The frame includes cutout regions to accommodate the lid of the casket, and the frame also includes a decorative cover to further conceal the separateness of the casket and the box during use.

### RELATED APPLICATION

This application claims priority to U.S. Provisional Patent Application Ser. No. 63/651,308, entitled “Funeral Service Container” and filed on May 23, 2024, which is expressly incorporated by reference herein, in its entirety.

### FIELD OF THE INVENTION

The present invention relates to a reusable funeral service container.

### BACKGROUND OF THE INVENTION

Caskets and cremation containers for adults, children, infants and preemies are available constructed from a myriad of different materials such as wood, metal or paper products. Caskets made from wood or metal are more attractive and desirable and are therefore more expensive. Caskets made from paper products can be simple or ornate but they are usually less costly compared to wood and metal.

In recent years reusable caskets have been developed to facilitate the temporary use of a metal or wood casket for a funeral services and related events. A reusable casket is more aesthetically pleasing and does not require the purchase of an expensive casket. Such reusable caskets have structural differences that allow them to be easily reused, and the deceased is removed therefrom after the funeral service. This approach enables the relatively expensive casket to be rented and used for the funeral services, rather than purchased.

Typically, the reusable casket is used in combination with a cardboard or paper-based box that fits therein. This approach, a single use box residing within a reusable casket, can be used whether the deceased is an adult, child, infant, or preemie, whenever cremation is contemplated, or even in situations where the remains will be placed in a crypt or vault.

For infants or preemies, the paper-based box that resides within the reusable casket resembles a traditional rectangular shoebox. The deceased fits inside the box for the funeral service. After the services, all casket bedding textiles, including the pillow, cushions, skirts, and hinge cover are folded into the container. Typically, a lid is then fitted over the container to close it off prior to cremation or entombment.

The present invention was developed to simplify the choices that funeral directors and grieving families of deceased infants or preemies have to make before, during, and after the presentation, cremation or burial of their deceased child, while also maintaining the dignity and the décor that are generally associated with funeral services.

### SUMMARY OF THE INVENTION

In situations where the deceased is a preemie baby or an infant, the present invention is a rental and cremation innovation that is designed to meet the needs of parents and funeral directors. For this scenario, the components are appropriately sized for prenatal (˜20″ interior) and infant (˜26″ interior) losses. Notably, most rental caskets are sized for adults and older children. The present invention enables an open casket presentation without the burdensome cost of purchasing a single use casket.

The present invention is also practical for funeral directors, because the cardboard box fills the need for a worthy transport container, with a lid, for transport of the deceased infant or preemie from the hospital to the funeral home. At the funeral home, the cremation box with child/preemie is placed directly into an aesthetically pleasing rental casket for the funeral service (i.e. ceremonies, religious services, layout, etc.). After the services, the cremation box, cushion, and pillow can be retrieved from the casket and then consumed in the cremation process. In those cases where a traditional burial is desired, the cremation box can be placed inside a vault for ground burial.

The inventive structure that facilitates cooperative use of the rented, reusable casket and the single use box, i.e., which holds the remains of the deceased, is a circumferential frame that covers the upper edges of the box and the casket when the box resides therein. In cross sectional view, this frame preferably has a downwardly directed U-shape which spans the respective upper edges of the outer casket and the box nested therein, around the entire periphery thereof, thereby to surround and conceal all of these upper edges. The frame conceals the fact that a box resides within a casket.

Preferably, the frame includes a decorative cover, which enhances the concealment. Further, the frame includes one or more cutout regions to accommodate a like number of casket hinges that allow a lid of the casket to be hingedly opened and closed, wherein the cutout regions enable the hinged opening and closing to occur uninterrupted by the frame.

This inventive frame meets the needs of both parents and funeral directors. In use, the frame is inserted inside the cremation box top edges and rests on top of the rental casket sides. As described, this frame minimizes costs for the funeral director and/or the parents.

The present invention provides a number of other advantages, as listed below.
Thin and Lightweight—The lightweight thin design of the decorative frame allows for easy removal but is strong enough to retain its shape and resist bending during removal and installation. The thickness allows for the lowering of the casket lid without obstruction.
Ease of Installation—The frame is installed in seconds by placing the frame on top of the rental casket sides. The hinge veil can be quickly secured to the back rail of the channel frame, thereby covering unsightly metal hinges.
Hinge Cutouts—Cutouts in the frame, along its backside, prevent interference with casket mounted hinges during casket lid closure.
Rental Casket Finish—The frame provides mounting surfaces for decorative cloth which is visible on all three outer external surfaces of the installed u channel frame. See Photo 2.
Decorative Surface Positioning—As decorative cloth is mounted to the upper surfaces, there is little potential for contact with the contained body. This allows for reuse of decorative cloth, thereby further reducing the cost.

The inventive frame allows the reuse of expensive decorative items that do not come in contact with the deceased preemie or infant during funeral services. In contrast, with current rental casket designs, all casket bedding textiles, including the pillow, cushions, skirts, and hinge cover, are folded into the container and consumed during cremation. For example, this inventive frame allows skirts and hinge covers which have not come into contact with the deceased to be reused, thereby again reducing costs.

These and other features of the invention will be more readily understood when considered in the context of the accompanying drawings, which are first described only briefly immediately below, but then thereafter described in more significant detail.

### BRIEF DESCRIPTION OF THE DRAWINGS

FIG. 1 is an exploded schematic view of a funeral services container according to a preferred embodiment of the invention.

FIG. 2 is an assemble perspective view of the funeral service container that is shown in FIG. 1.

FIG. 3 is another perspective view of the frame showing the decorative cover thereon in accord with another aspect of the present invention.

FIG. 4 is a bottom perspective of the frame.

FIG. 5 is a cross-sectional view the funeral services container of the present invention, and ready for use.

### DETAILED DESCRIPTION OF THE DRAWINGS

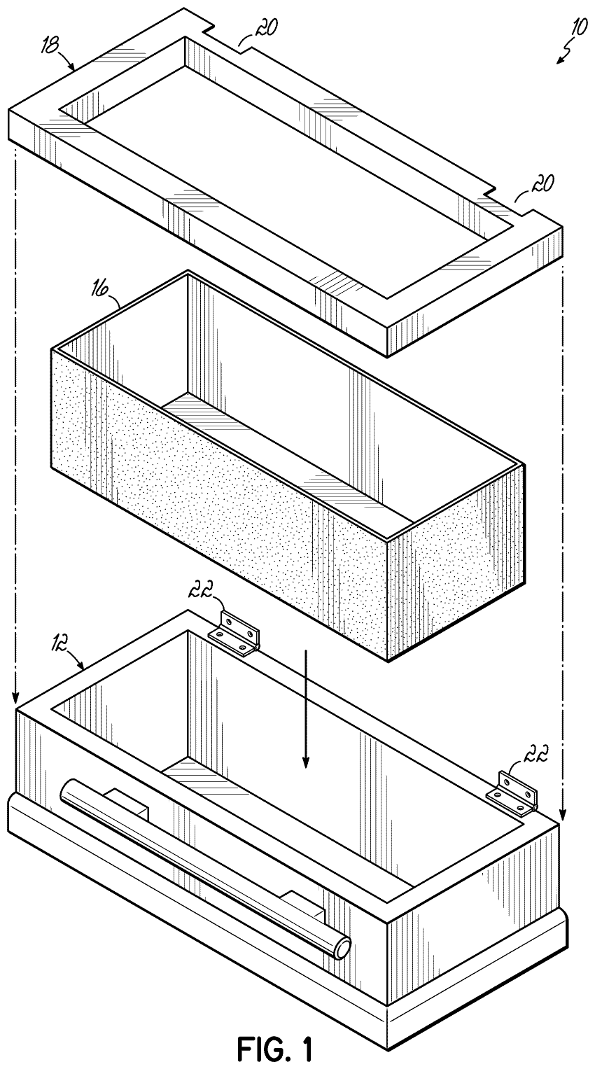

FIG. 1 shows, in schematic and exploded format, a funeral service container 10 according to a currently preferred embodiment of the invention. The container 10 includes a base, i.e. a casket, 12 located at the bottom, and shown in an open condition. The casket 12 has a hingedly connected lid 14, to enable opening and closing of the casket 12, but the lid 14 is not shown in FIG. 1. A paperboard box 16 resides above the casket 12, and is generally sized and shaped to be easily received therein, and also removable therefrom. A frame 18 resides above the box 16, but in FIG. 1 the frame 18 is shown in a condition whereby it is rotated upwardly so as to show a horizontal cross-sectional view therethrough. In vertical cross section, each side of the frame 18 has a downwardly directed U-shape, and is generally sized to fit over and cover the corresponding upper edges of both the box 16 and the casket 12, completely around the entire periphery thereof. Further, FIG. 1 shows that the frame 18 includes cutouts 20 located so as to accommodate hinges 22 of the casket 12.

During use, the cremation box 16 nests within the casket 12, and contains the remains of the preemie/infant. As noted above, the cremation box 16 could be generally about the size of a typical shoebox. After use, the cremation box 16 is removed from the casket 12. Preferably, the cremation box 16 has a removable lid (not shown) that may be placed on top thereof when the funeral service is over, so that the lidded cremation box 16 can then be taken to a cremation site or to a burial site, such as a burial vault.

Again, FIG. 1 shows the frame 18 located above the cremation box 16, and also tilted 90 degrees forward so as to show a top view, or plan view, thereof. In use, this frame 18 resides over and thereby spans the top edges of the cremation box 16 that is nested within the casket 12, so as to frame the open top end of the casket 12.

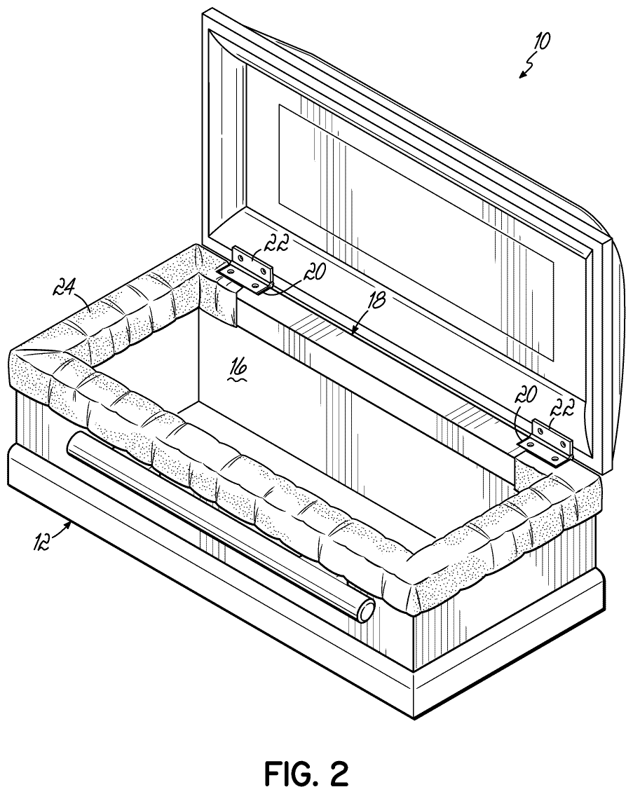

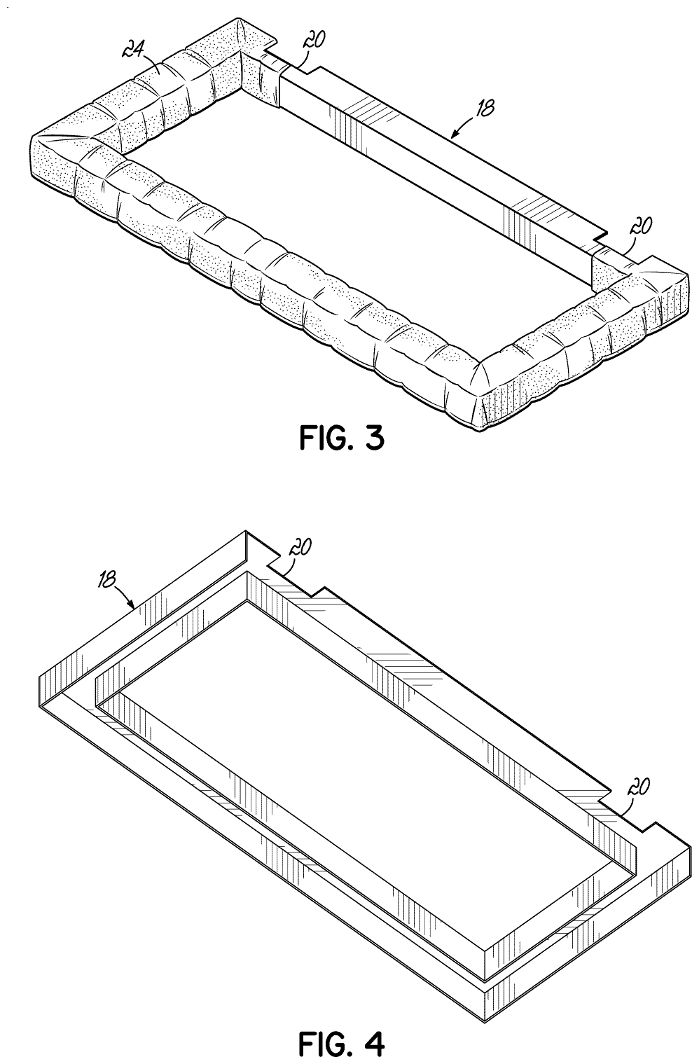

Because FIG. 2 shows the frame 18 in an inverted condition, FIG. 2 shows the downwardly directed U-shape of the frame 18, along three sides thereof. FIG. 2 also shows the cutout regions 20 which accommodate the hinges 22 of the casket 12, to facilitate opening and closing thereof. In contrast, the front top view of FIG. 3 shows the frame 18 with a decorative cover 24 thereon, which further enables the frame 18 to conceal the separateness of the casket 12 and the box 16.

Both of FIGS. 2 and 3 show that the frame 18 includes two rear cutout regions which correspond to the locations of the hinges of the casket 12. This enables the lid of the casket 12 to be closed or opened, as desired, without disturbing the location of the frame 18. Also, the horizontal cross section of the frame 18 can be sized so as to merely cover the top edges, or to snugly hold the top edges, depending on the preferred construction.

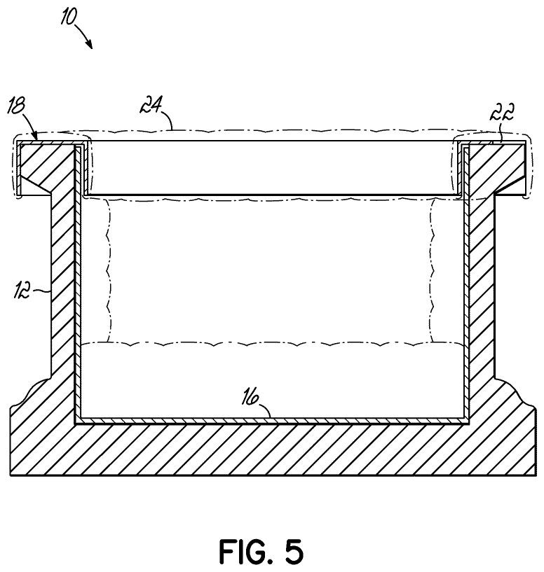

FIGS. 4 and 5 show an open casket 12, with the frame 18 in place, and covered with a decorative cloth 24 around the entire perimeter. The difference is that FIG. 4 is a front view and FIG. 5 is a top perspective view. As shown in these Figs, the frame 18 creates the impression that it is a part of the typical high-end casket, including the typical decorations. Nonetheless, with this invention the frame 18 and the casket 12 are reusable, whereas the cremation box 16 is not reusable, but only a single use.

The incorporated provisional application shows in more detail two slightly different versions of the frame 18.

This specification describes a presently known exemplary embodiment of this invention. Those skilled in the art will recognize that this specification is not intended to be limiting in scope to the specific details shown and described. Rather, the scope of the invention is defined by the following claims. Further, in the claims the invention is referred to as a “funeral service container” but that phrase is not intended to be limiting. For example, it is not intended to require any particular use of the described structure, or non-use for that matter.

I claim:

1. A funeral service container comprising:
a casket, the casket having a lid hingedly connected thereto via at least one hinge located along one side thereof, and the lid being hingedly movable to open and to close the casket;
a box residing in the casket, the box having top edges thereof at about the same vertical height as top edges of the casket; and
a frame residing over and spanning the top edges of the casket and the box, thereby to cover the top edges thereof completely therearound the box and the casket, and wherein the lid retains the ability to open and to close while the frame remains in place.

2. The funeral service container of claim 1 wherein the frame includes at least one cutout region that corresponds to the at least one hinge of the lid, to accommodate the opening and closing of the lid with the frame in place.

3. The funeral service container of claim 1 and further comprising:
a decorative cover on the frame.

4. The funeral service container of claim 1 wherein the frame, in cross-section, has an inverted U-shape.
